(19) United States
(12) Patent Application Publication
(10) Pub. No.: US 2010/0197259 A1
(43) Pub. Date: Aug. 5, 2010

(54) METHOD AND APPARATUS FOR PRODUCING SIGNAL USED FOR VERIFYING THE PERFORMANCE OF STANDARD RADIO RECEIVER

(76) Inventors: Fang Chen, Beijing (CN); Yong Guan, Beijing (CN); Zhenfeng Zhao, Beijing (CN); Zhijian Hu, Beijing (CN)

Correspondence Address: TUROCY & WATSON, LLP, 127 Public Square, 57th Floor, Key Tower, CLEVELAND, OH, 44114, US

(21) Appl. No.: 12/600,973

(22) PCT Filed: May 22, 2008
(86) PCT No.: PCT/CN2008/071056

§ 371 Date: Apr. 8, 2010

(30) Foreign Application Priority Data
May 24, 2007 (CN) 200710099543.3

(51) Int. Cl. H04B 17/00

(52) U.S. Cl. 455/226.1

(57) ABSTRACT

A method and an apparatus for producing a signal for verifying performances of a standard radio receiver. The apparatus includes a control module adaptable for controlling data processing, a program module for controlling and storing a digital simulation signal, a conversion module carrying out D/A conversion for the digital simulation signal, and a simulation module. When validating whether the standard radio receiver is compliant to IEEE 802.15.4-2006 standard, a verifier only needs to set up parameters defining types and signal strengths of a data frame w/o noise signals, time intervals for sending out the data frame, and a count of times of sending the data frame. Based on predefined parameters, the simulation module generates a digital simulation signal which is then processed by successive hardware devices to generate a simulated verification signal needed for validating the standard radio receiver.

### BACKGROUND OF THE INVENTION

1. Field of the Invention

The present invention relates to a method and an apparatus for producing signals for verifying performances of a standard radio receiver, and more particularly, to verifying the compliance of the performances of the standard radio receiver with the IEEE 802.15.4-2006 standard in the chip design field.

2. Description of the Prior Art

In the chip design of a standard radio receiver with different frequencies and different debug modes compliant to the IEEE 802.15.4-2006 standard, the standard is so new that after the chip is developed, no apparatus can be used to validate whether the chip is compliant to the IEEE 802.15.4-2006 standard. Thus, when developing the chip compliant to the IEEE 802.15.4-2006 standard, a method and an apparatus for chip verification are desirable.

### SUMMARY OF THE INVENTION

The present invention intends to provide a method and an apparatus for producing signals adaptable for verifying the performances of a standard radio receiver, especially a radio receiver compliant to IEEE 802.15.4-2006 standard, and also to provide a method and an apparatus to a verifier who is dedicated in developing the IEEE 802.15.4-2006 standard chip, so as to accelerate the progresses of design, verification, and test.

The present method for producing signals adaptable for verifying the performance of standard radio receiver includes following steps:
(1) individually sampling a standard verification signal emitted from a standard radio transmitter corresponding to a standard radio receiver to be validated and a simulated noise signal capable of disturbing the performance of the standard radio receiver to obtain a digital sequence;
(2) converting the digital sequence into a binary form to generate a digital simulation signal; and
(3) converting the digital simulation signal into a simulated verification signal for verifying the performances of the standard radio receiver.

The present apparatus for producing a signal for verifying the performance of the standard radio receiver, includes:
a simulation module, adaptable for sampling the standard verification signal emitted by the standard radio transmitter corresponding to the standard radio receiver to be validated and the simulated noise signal capable of disturbing the performance of the standard radio receiver in order to obtain a digital sequence, and convert the digital sequence into a binary form to generate a digital simulation signal;
a control module, connected to an Ethernet port of the simulation module via an Ethernet controller, adaptable for establishing a data channel between a program module and the simulation module, and generating an enable signal that activates the program module;
the program module, connected to the control module, adaptable for storing the digital simulation signal generated by the simulation module, and controlling a conversion module to perform a digital to analog (D/A) conversion; and
the conversion module, connected to the program module, adaptable for converting the digital simulation signal of the program module into the simulated verification signal to verify the performance of the standard radio receiver.

In aforementioned apparatus, the control module comprises:
a central processing unit (CPU) connected to a non-volatile memory, a dynamic random access memory (DRAM), the Ethernet controller and the program module for controlling data communications between the Ethernet and the simulation module and data communications with the program module;
the non-volatile memory connected to the CPU, adaptable for storage of programs for control of the CPU and data communications between the control module and the simulation module;
the DRAM, preferably a synchronous DRAM, connected to the control module, adaptable for reading programs for control of the control module from the non-volatile memory and reading the data generated from operations performed by the control module; and
the Ethernet controller, connected to the control module and the simulation module, adaptable for establishing high-speed data connections between the control module and the simulation module.

In the aforementioned apparatus, the program module comprises:
a Field Programmable Gate Array (FPGA), adaptable for controlling a static random access memory (SRAM) for storage of the digital simulation signal and generating a control signal for the conversion module to start the D/A conversion, and the FPGA is connected to the SRAM, a configuration memory, a clock, and the conversion module;
the SRAM, connected to the FPGA, adaptable for storing the digital simulation signal generated by the simulation module;
the configuration memory, connected to the FPGA, adaptable for storing the control program of the FPGA; and
the clock, connected to FPGA, adaptable for generating the clock signal that the FPGA needs.

In aforementioned apparatus, the conversion module comprises:
a digital to analog converter (DAC) connected to two differential to single-ended circuits and two test ports, adaptable for converting the digital simulation signal output from the FPGA into the simulation signal;
a differential to single-ended circuit is adaptable for converting a differential signal output from the DAC into a single-ended signal; and
a test port, connected to the differential to single-ended circuit, adaptable for testing the simulation signal output from the DAC.

The present method and apparatus for producing signal used for verifying the performance of the standard radio receiver have the following advantages:
(1) Universality: There are many ways in designing a radio transceiver chip compliant to IEEE 802.15.4-2006 standard, but only one apparatus capable of generating IEEE 802.15.4-2006 standard signals is required to validate whether the chip is compliant to IEEE 802.15.4-2006 standard, Thus, the universality in validation of various different transceiver chips of such a standard can be implemented.
(2) Convenience: When verifying the performance level of a standard radio receiver chip compliant to IEEE 802.15.4-2006 standard, a verifier can flexibly select or allocate noise signal modules to validate performance levels of different functionalities in the radio receiver chip.
(3) Ease of test: The design has two test ports facilitating external tests and observations on the data output from the test ports.

### BRIEF DESCRIPTION OF THE DRAWINGS

FIG. 1 is a block diagram of an embodiment of a verification apparatus for producing a signal to verify the performance of a standard radio receiver.

FIG. 2 is a circuit block diagram of a control module according to the embodiment of the verification apparatus.

FIG. 3 is a circuit block diagram of a program module according to the embodiment of the verification apparatus.

FIG. 4 is a circuit block diagram of a conversion module according to the embodiment of the verification apparatus.

FIG. 5 is a block diagram of a simulation module according to the embodiment of the verification apparatus.

### DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

An embodiment of the method for producing a signal for verifying the performances of a standard radio receiver includes following steps:
(1) individually sampling a standard verification signal emitted by a standard radio transmitter corresponding to the standard radio receiver to be validated and a simulated noise signal capable of disturbing the performance of the standard radio receiver to obtain a digital sequence;
(2) converting the digital sequence into a binary form to generate a digital simulation signal; and
(3) converting the digital simulation signal into a simulated verification signal for verifying the performance of the standard radio receiver.

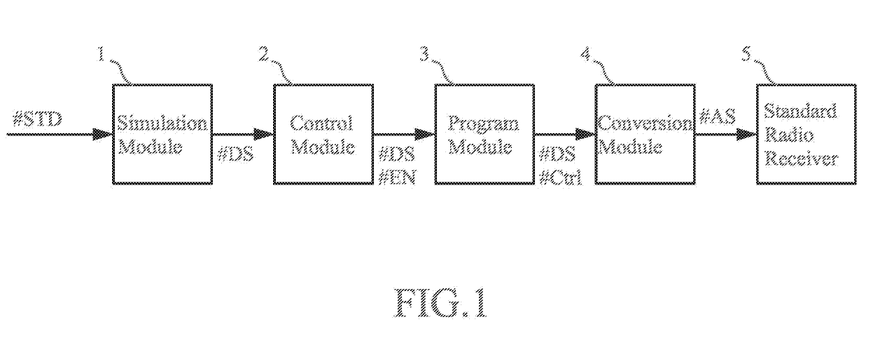

Referring to FIGS. 1 to 5, an embodiment of a verification apparatus for producing an simulated verification signal #AS for verifying the performance of a standard radio receiver 5 includes:
a simulation module 1, adaptable for sampling a standard verification signal #STD emitted by a standard radio transmitter (not shown) corresponding to the standard radio receiver 5 to be validated and a simulated noise signal #NS capable of disturbing the performance of the standard radio receiver 5 to generate a digital sequence, and converting the digital sequence into a binary form to generate a digital simulation signal #D S;
a control module 2, connected to an Ethernet port of the simulation module 1 via an Ethernet controller 240, serving as a communication bridge between a program module 3 and the simulation module 1, and generating an enable signal #EN that can make the program module 3 take action;
the program module 3, connected to the control module 2, used to store the digital simulation signal #DS generated by the simulation module 1, and control a conversion module 4 to perform a digital to analog (D/A) conversion; and
the conversion module 4, connected to the program module 3, used to convert the digital simulation signal #DS passed from the program module 3 into the simulated verification signal #AS for verifying the performance of the standard radio receiver.

In the aforementioned verification apparatus, the control module 2 comprises a central processing unit (CPU) 210 adaptable for controlling data communications with the simulation module 1 via an Ethernet controller 240, and data communications with the program module 3, and the CPU 210 is connected to a non-volatile memory 230, a dynamic random access memory (DRAM) 220, the Ethernet controller 240 and the program module 3.

The non-volatile memory 230 is connected to the CPU 210, adaptable for storing a control program for the CPU 210 to execute, and a driver program controlling the communications between the control module 2 and the simulation module 1.

The DRAM 220 (preferable a synchronous DRAM), is connected to the CPU 210, adaptable for buffering the control program read from the non-volatile memory 230 and working data generated by the CPU 210 when the control program is executed.

The Ethernet controller 240 is connected to the CPU 210 and the simulation module 1, adaptable for establishing high-speed data connections between the CPU 210 and the simulation module 1.

In the aforementioned verification apparatus, the program module 3 comprises a FPGA 310 adaptable for controlling a static random access memory (SRAM) 330 to store the digital simulation signal #DS and generating a control signal #Ctrl to the conversion module 4 to trigger the D/A conversion process, and the FPGA 310 is connected to the SRAM 330, a configuration memory 320, a clock 340, and the conversion module 4.

The SRAM 330 is connected to the FPGA 310, adaptable for storing the digital simulation signal #DS generated by the simulation module 1.

The configuration memory 320 is connected to the FPGA 310, storing a program for controlling the FPGA 310.

The clock 340 is connected to the FPGA 310, and adaptable for generating a clock signal as a basis for the FPGA 310 to work.

In the aforementioned verification apparatus, the conversion module 4 comprises a digital to analog converter (DAC) 410 adaptable for converting the digital simulation signal #DS output from the FPGA 310 into an simulated verification signal #AS in a differential signal form, and the DAC 410 is connected to two differential to single-ended circuits 420, 430 and two test ports 440, 450.

The differential to single-ended circuits 420 and 430 each is adaptable for converting the simulated verification signal #AS output from the DAC 410 into a single-ended signal form.

The test ports 440 and 450 are respectively connected to the differential to single-ended circuits 420 and 430, adaptable for outputting the simulated verification signal #AS converted from the DAC 410 for external tests and observations.

In following text, the present invention is described in details with reference to the accompanying drawings.

The present embodiment of the verification apparatus for producing a signal adaptable for verifying the performance of the standard radio receive, as shown in FIG. 1, includes the control module 2, the program module 3, the conversion module 4 and the simulation module 1.

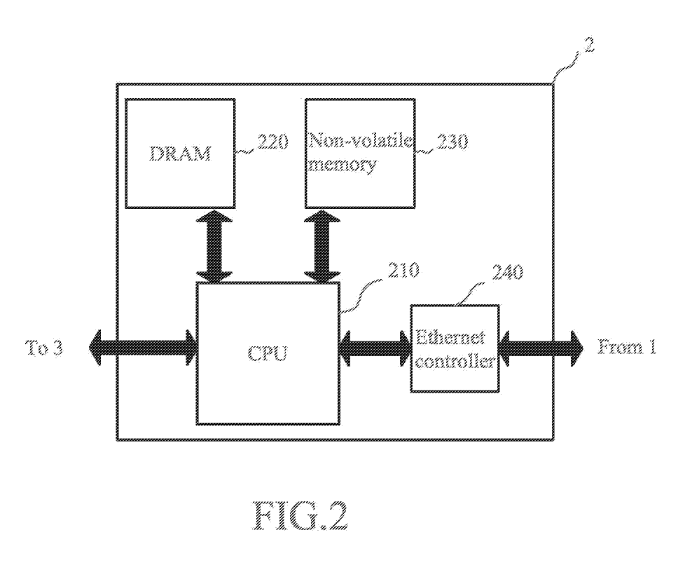

The circuit block diagram of the control module 2 in the verification apparatus is shown in FIG. 2. The control module 2 comprises a CPU 210 such as S3C2410-ARM9, for controlling data communications with the simulation module 1 over Ethernet, and data communications with the program module 3. The CPU 210 is connected to the non-volatile memory 230, the DRAM 220, the Ethernet controller 240 and the program module 3.

The non-volatile memory 230 is connected to the CPU 210, and uses a chip such as a K9F1208 chip, for storing a control program for the CPU 210 to execute, and a driver program controlling the communications between the CPU 210 and the simulation module 1.

The DRAM 220, preferably a synchronous DRAM, is connected to the CPU 210, using a chip such as a HY57V561620CT chip, for buffering the control program read from the non-volatile memory 230 and working data generated from programs executed by the CPU 210.

The Ethernet controller 240 is connected to the CPU 210 and the simulation module 1, using a chip such as a DM9000 chip, for establishing high-speed data connection between the CPU 210 and the simulation module 1.

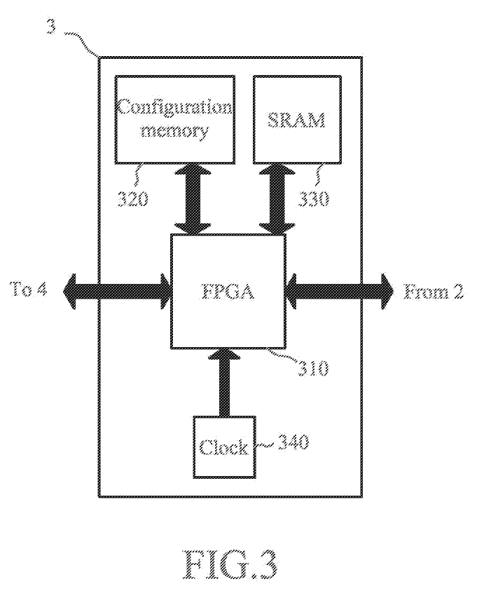

The circuit block diagram of the program module 3 in abovementioned apparatus is shown in FIG. 3.

The program module 3 comprises a Field Programmable Gate Array (FPGA) 310 such as a XC3S200 chip, for controlling the SRAM 330 to store the digital simulation signal #DS and generating a control signal #Ctrl to the conversion module 4 to trigger the D/A conversion process. The FPGA 310 is connected to the SRAM 330, the configuration memory 320, the clock 340 and the conversion module 4.

The SRAM 330 is connected to the FPGA 310, using a chip such as an IS61LV12816L chip, for storing the digital simulation signal #DS generated by the simulation module 1.

The configuration memory 320 is connected to the FPGA 310, using a chip such as a XCF01S chip, for storing a program for control of the FPGA 310.

The clock 340 is connected to the FPGA 340, adaptable for generating a clock signal as a basis for the FPGA 310 to work.

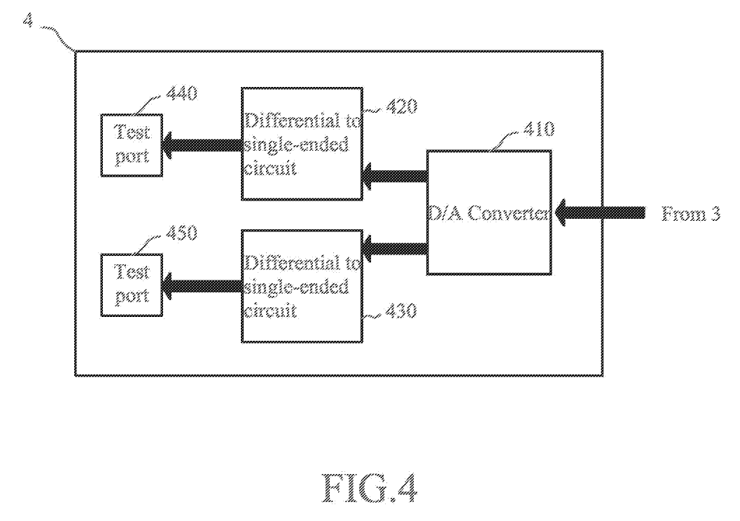

The circuit block diagram of the conversion module 4 in aforementioned verification apparatus is shown in FIG. 4.

The conversion module 4 comprises a DAC 410 such as a AD9761 chip, for converting the digital simulation signal #DS output from the FPGA 310 into the simulated verification signal #AS, and is connected to two differential to single-ended circuits 420, 430 and two test ports 440, 450.

The differential to single-ended circuits 420 and 430, for example, may be AD8042 chips, for converting a differential signal such as the simulated verification signal #AS output from the DAC 410 into a single-ended signal form.

The test ports 440 and 450 are connected to the differential to single-ended circuits 440 and 450, respectively, adaptable for outputting the simulated verification signal #AS of the single ended signal form for external tests or observations.

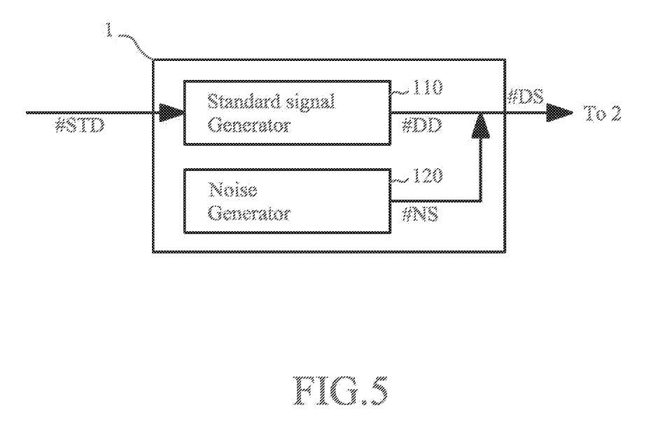

The simulation module 1 in aforementioned apparatus includes two function modules as shown in FIG. 5, a standard signal generator 110 and a noise generator 120.

In an embodiment of the standard signal generator 110, according to the standard signal defined in IEEE802.15.4-2006 standard, the standard signal generator 110 samples the standard verification signal #STD for a sampling period long enough for the verification to obtain a sampled pulse signal, and quantizes the sampled pulse signal into to a value range required for the verification. The quantized samples are then encoded to generate a digital standard signal #DD representative a digital form of the standard verification signal #STD specified in IEEE802.15.4-2006 standard. Further hardware may be incorporated to validate whether the performances of the standard radio receiver 5 is IEEE802.15.4-2006 standard compliant when a simulated verification signal #AS representative of the digital standard signal #DD is transmitted.

Regarding the sampling period, according to the sampling theorem, a continuous signal is repeatedly sampled in a certain time interval to generate a discrete pulse signal. The sampling theorem says, if the highest frequency or bandwidth of a continuous signal is Fmax, and if the sampling period is T, the sampling frequency is F=/T, and if F=1/T>=2Fmax which means the sampling frequency is larger than or equal to twice the highest frequency of the signal, the sampled discrete serial can be used to reconstruct the original continuous signal without distortion.

In an embodiment of quantization, the sampled pulse signal is compared to a plurality of predefined magnitude levels and rounded off into the closest magnitude level, so as to generate the digital standard signal #DD.

In an embodiment of encoding, the digital standard signal is a quantized result encoded into a binary form with certain bit-widths.

In an embodiment of the noise generator 120, various kinds of noise modules capable of disturbing the performance of the standard radio receiver, such as an initial phase signal module, a frequency deviation signal module, a phase noise signal module, an I path and Q path gain imbalance signal module, an I path and Q path phase imbalance signal module, a nonlinear noise signal module, a multipath signal module, a Gauss noise signal module, an adjacent channel interference signal module, a single-frequency interference signal module, and so on, can be employed. All noise modules are independent to each other, and a verifier can employ one or more of them according to various standard defined criteria in implementing a receiver chip. Hence, the simulation module 1 can incorporate the standard signal generator 110 and the noise generator 120 to respectively generate a digital standard signal #DD and a noise signal #NS, and add them correspondingly to generate the digital simulation signal #DS, and the digital simulation signal #DS can be further converted and transmitted by following hardware to verify whether the performance of the standard radio receiver 5 satisfies the standard criteria under the disturbance of the simulated noise signal #NS generated within the standard defined range of signal to noise ratio (SNR).

In the simulation module 1, all kinds of noise modules discussed in the noise generator 120 can be individually implemented. When performing the verification, the verifier may select different signal modules based on the criteria of IEEE 802.15.4-2006 standard so as to make the verification apparatus generate a simulated verification signal #AS correspondingly for validating whether the chip is compliant to IEEE 802.15.4-2006 standard, and such that the verification can be carried out. For example: if only the standard signal generator 110 is enabled while the noise generator 120 is disabled, the digital simulation signal #DS generated by the simulation module 1 is exactly identical to the standard verification signal #STD emitted by a standard transmitter corresponding to the verification standard radio receiver, and with the cooperation of hardware, the digital simulation signal #DS can be further converted and transmitted to validate the compliance of a radio receiver with the IEEE 802.15.4-2006 standard. If there is a need to verify various functionalities of the chip specified in the IEEE 802.15.4-2006 standard, for example, whether the performance under disturbances of the initial phase signal and the Gauss noise signal satisfies the criteria of the standard, an initial phase signal module and a Gauss noise signal module in the noise generator 120 can be enabled as well as the standard signal generator 110, while other noise modules within the noise generator 120 are disabled, with parameters such as SNR properly defined based on the IEEE 802.15.4-2006 standard, to generate a simulated noise signal #NS capable of disturbing the performance of the standard radio receiver 5, and such that the compliance of the standard radio receiver with the IEEE 802.15.4-2006 standard can be examined.

An embodiment is illustrated as follows:
When verifying a standard radio receiver, the embodiment of the verification apparatus according to the invention can either validate whether the chip is compliant to IEEE 802.15.4-2006 standard, or whether the performances of the chip satisfy the criteria specified in IEEE 802.15.4-2006 standard. The embodiment of the verification apparatus is shown in FIG. 1.

For the case of verifying the compliance of IEEE 802.15.4-2006 standard for a standard radio receiver, only the standard signal generator 110 in FIG. 5 is enabled, while the noise generator 120 is disabled. A verifier may input a standard data frame (standard verification signal #STD) to be verified to the simulation module 1 of the present apparatus, and consequently the simulation module 1 generates a digital simulation signal #DS corresponding to the data frame. The digital simulation signal #DS is then transmitted to the control module 2 through an Ethernet port. The control module 2 sends the digital simulation signal #DS to the program module 3 for storage, and the stored digital simulation signal #DS is then converted into a simulated verification signal #AS by the conversion module 4. The simulated verification signal #AS is output by the differential to single-ended circuits 420 and 430, and used as a representative of the standard verification signal #STD for verifying the standard radio receiver 5. The only thing a verifier needs to do is to observe whether an output data frame received by the standard radio receiver subsequently matches the original input standard data frame. Thus, the embodiment shows a convenient approach to validate the compliance of the standard radio receiver with the IEEE 802.15.4-2006 standard.

There are various kinds of noises in the practical environment, and it is very difficult to find a particular environment that provides all kinds of noises in verifying the standard radio receiver. The embodiment of the verification apparatus implements various independent noise signal modules to simulate the real world environment, which is convenient for a verifier to verify whether the radio receiver chip satisfies various performance criteria under the disturbances of particular kinds of noises as specified in the standard. The noise generator 120 may comprise various independent noise signal modules (not shown), and the verifier can flexibly select one or more noise modules and set up noise parameters such as SNR to standard required values to simulate an environment for verification, and these procedure are easy and convenient. If the verifier wants to simulate a noise environment with phase noise, frequency deviation, and multipath noise, he just needs to input the standard data frame to the simulation module 1, selectively enable the phase noise, frequency deviation, and multipath noise modules, and set up the noise parameters to a predetermined range as specified by the standard, and such that a simulated environment is established for verifying the performance of the radio receiver chip.

In order to facilitate the repetitive verification works in the chip fabrication processes of the standard radio receivers, the simulation module 1 can be employed to set up data frames, noise signals, time intervals between sending the data frame, and the count of times to send the data frames. With the customizable parameters, the simulation module 1 is able to repetitively generate series of digital simulation signals #DS which are then converted and output as needed in the following hardware components. It is shown that the embodiment is advantageous in its convenience and flexibility.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for producing a signal for verifying performances of a standard radio receiver, comprising:
individually sampling a standard verification signal emitted by a standard radio transmitter corresponding to the standard radio receiver to be validated and a simulated noise signal capable of disturbing the performances of the standard radio receiver to generate a digital sequence;
converting the digital sequence into a binary form to generate a digital simulation signal; and
converting the digital simulation signal into an simulated verification signal for verifying the performance of the standard radio receiver.

2. An apparatus for producing a signal for verifying performances of a standard radio receiver, the apparatus comprising:
a simulation module, for sampling a standard verification signal emitted by a standard radio transmitter corresponding to the standard radio receiver to be validated and the simulated noise signal capable of disturbing the performance of the standard radio receiver to generate a digital sequence, and converting the digital sequence into a binary form to generate a digital simulation signal;
a control module, connected to an Ethernet port of the simulation module via an Ethernet controller, for establishing a data channel between a program module and the simulation module, and generating an enable signal #EN to activate the program module;
the program module, connected to the control module, for storage of the digital simulation signal generated by the simulation module, and control of a conversion module to perform a digital to analog conversion; and
the conversion module, connected to the program module, for converting the digital simulation signal into an simulated verification signal for verifying the performances of the standard radio receiver.

3. The apparatus of claim 2, wherein the control module comprises:
a central processing unit, connected to the program module, controlling data communications between the Ethernet and the simulation module, and data communications with the program module;
a non-volatile memory, connected to the central processing unit, for storage of a control program to be executed by the central processing unit, and a driver program controlling the communications between the central processing unit and the simulation module;
a dynamic random access memory, connected to the central processing unit, for buffering the control program read from the non-volatile memory and data generated from the control program executed by the central processing unit; and
an Ethernet controller, connected to the central processing unit and the simulation module, for establishing high-speed data connections between the central processing unit and the simulation module.

4. The apparatus of claim 2, wherein the program module comprises:
a field programmable gate array (FPGA), connected to the conversion module, for controlling a static random access memory to store the digital simulation signal and generating a control signal to the conversion module to trigger a digital to analog conversion process;
a static random access memory, connected to the FPGA, for storage of the digital simulation signal generated from the simulation module;
a configuration memory, connected to the FPGA, for storage of a program for controlling the FPGA; and
a clock, connected to the FPGA, for generating a clock signal as a basis for the FPGA to work.

5. The apparatus of claim 2, wherein the conversion module comprises:
a digital to analog converter (DAC) for converting the digital simulation signal output from the program module into the simulated verification signal; wherein the simulated verification signal is in a differential signal form;
two differential to single-ended circuits, each connected to the DAC, for converting the simulated verification signal output from the DAC into a single-ended signal form respectively; and
two test ports, each connected to one of the differential to single-ended circuits respectively, for outputting the simulated verification signal of the single-ended signal form.
